(19) United States
(12) Patent Application Publication
(10) Pub. No.: US 2026/0149299 A1
(43) Pub. Date: May 28, 2026

(54) Electrical Measurement and Power Management System and Method for Dual Power Source Installation

(71) Applicant: Koolbridge Energy, Inc., Wrightsville Beach, NC (US)

(72) Inventor: Paul Wilkinson Dent, Pittsboro, NC (US)

(21) Appl. No.: 19/398,867

(22) Filed: Nov. 24, 2025

Related U.S. Application Data
(60) Provisional application No. 63/724,634, filed on Nov. 25, 2024.

(51) Int. Cl. H02J 9/06

(52) U.S. Cl. CPC H02J 9/06

(57) ABSTRACT

In a dual-power source electrical installation, load circuits are selectively switched between first and second power sources under control of a processor. Switching circuits and their control, operative to safely switch the loads while avoiding source-to-source arcing, are described. Additionally, algorithms are described for power management executed by the processor in order to maximize performance from the user's viewpoint. Maximizing performance can include minimizing the utility bill and/or providing as many appliances as possible with the opportunity to have power in the event of a primary power source outage. The algorithms divide broadly into two classes. First, algorithms that are operable when both primary and alternative power sources are available to minimize the use of expensive utility power. Second, algorithms that are operable when the primary utility power source is in outage to offer power to as many appliances as possible while avoiding overload of the alternative power source.

### CROSS REFERENCE TO RELATED APPLICATIONS

This application claims priority to provisional patent application Ser. No. 63/724,634 filed Nov. 25, 2024, titled “Electrical Measurement and Power Management Device for Dual Power Source Installation,” the disclosure of which is incorporated by reference herein in its entirety.

### FIELD OF INVENTION

The present invention relates generally to electrical power distribution, and in particular to an intelligent management of dual power sources, such as electrical utility grid power and solar power, for residential or commercial electrical installations.

### BACKGROUND

Global climate change is driving a move away from fossil fuels and towards renewable energy sources for providing power to residences and businesses. The falling cost of photovoltaic panels makes power derived from solar insolation particularly attractive. Photovoltaic panels convert solar energy into Direct Current (DC) voltage. This may be stored directly (with level-shifting and other conditioning) by rechargeable batteries. It may be converted to Alternating Current (AC) voltage to feed power a utility power grid, or to be used directly by appliances, machinery, and the like. DC to AC conversion is performed by equipment commonly referred to as an “inverter.” Conventionally, solar power installations utilize an inverter configured as a current source, to supply power to the utility power grid which determines the voltage (a so-called “grid-tie” inverter). To directly power AC loads, an inverter is configured as a constant voltage source supplying current determined by attached loads, known as a “stand-alone” inverter.

Initially, almost all residential solar power installations employed grid-tie inverters and could only supply power to the grid. As solar powered homes proliferate, utility grids may reach their capacity on sunny days, and cannot take more power. Additionally, during a grid outage, such as in the aftermath of severe weather, grid-tie inverters are incapable of powering household loads. Increasingly, there is interest in residential and commercial solar power installations utilizing stand-alone inverters to directly power loads. Due to little insolation during cloudy weather, and none at night, solar installations with stand-alone inverters must utilize batteries to store power for off-hours delivery, and/or retain a power connection to the electrical utility grid.

The Applicant of the present disclosure owns numerous patents relating to solar power systems in general, and in particular to “smart” (i.e., processor-based) control of an electrical breaker panel that enables the selection of grid or alternative (e.g., solar-derived) power on a per-branch circuit basis. See, e.g., U.S. Pat. Nos. 8,937,822; 9,735,703; 10,135,361; 10,951,027; 11,460,488; 11,901,810; and 12,160,168; the disclosures of all of which are incorporated herein by reference in their entireties.

While intelligently switching a load between two power sources is conceptually simple, safe and effective implementation is fraught with challenges. Relay contacts are known to arc upon breaking during current flow, which can lead to numerous failure modes. To safely implement power source switching, current flows should be monitored. However, known current sensors are noisy and, when integrated closely together, subject to crosstalk, which complicates current monitoring. Aside from the circuit and control level challenges of implementing power source switching, numerous factors must be considered in designing energy management algorithms to implement automated power source switching, while remaining with the instantaneous and steady-state capacity limitations of the alternative energy system components.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

An intelligent management of dual power sources such as electrical utility grid power and solar power to reduce cost and/or provide back-up power for residential or commercial electrical installations

An intelligent electrical panel may be a single phase panel adapted to operate with single phase supplies of 240 volts, as used typically in Europe; a split-phase panel using single phase 240 volts center-tapped (120-0-120), also known as split-phase and used in US residential installations; or three-phase 120/208 volts as may be used in US commercial or industrial installations. The intelligent panel comprises circuit breakers for each branch circuit; source selection switches associated with each breaker to select power from either a primary source or an alternative energy source, or neither; current sensors to measure and digitize the current drawn by each branch circuit; voltage sensors to measure and digitize the voltage of each phase of each source, and a processor to read the digital current and voltage measurements and to control the source selection switches in dependence thereon. The processor may also be provided with any or all of the following information on which to base its actions.
The continuous and momentary current or power capability of any power source;
The nature of the load connected to each branch circuit;
The continuous and start-up current or power requirements of any load connected to a branch circuit;
Time of day from a real-time clock;
Cost of utility power versus time of day;
Amount of solar or other alternative power generation momentarily being received;
Charge state of a battery or other energy storage means;
Priorities at different times of day determined by the user for loads to be backed up in the case of primary power source outage;
Tariffs versus time of day for utility grid power; and
Weather predictions received over a communications link.

Algorithms are described for power management executed by the processor in order to maximize performance from the user's viewpoint. Maximizing performance can include minimizing the utility bill and/or providing as many appliances as possible with the opportunity to have power in the event of a primary power source outage. The algorithms divide broadly into two classes. First, algorithms that are operable when both primary and alternative power sources are available to minimize the use of expensive utility power. Second, algorithms that are operable when the primary utility power source is in outage to offer power to as many appliances as possible while avoiding overload of the alternative power source.

Intelligent electrical panels for operation with primary and secondary power sources are described in U.S. Pat. Nos. 11,901,810; 11,460,488; 10,951,027; 10,536,039; 10,135,361; and 9,735,703 to the current inventor. This disclosure describes further development and improvements to the same, including improvements to source selection switching, improvements to current sensing accuracy, and improvements to energy management algorithms.

One aspect relates to a switching circuit configured to switch a load between first and second power sources without the possibility of source-to-source arcing. The switching circuit includes a first relay having a first terminal, and a second terminal connected to the first power source. The switching circuit also includes a second relay having a first terminal connected to the load, a second terminal connected to the second power source; and a third terminal connected to the first terminal of the first relay. The switching circuit further includes a control circuit configured to independently and selectively energize the first and second relays so as to switch the load between the first and second power sources while avoiding source-to-source arcing.

Another aspect relates to an electrical circuit breaker panel configured to selectively distribute split-phase power to a branch circuit or appliance from one of a primary split-phase power source and a secondary split-phase power source, through an appropriate two-pole circuit breaker. The panel includes a set of controlled switches configured to independently connect each pole of the circuit breaker to, and disconnect it from, each of the primary or secondary split-phase power sources. The panel further includes a controller configured to control the switches to power the branch circuit or appliance from the primary or secondary split-phase power source. To change the selection for the two-pole breaker from one of the primary or secondary split-phase power sources to the other, the controller is configured to control the switches in the following sequence: disconnect a first pole of the two-pole breaker from a currently selected split-phase power source and verify that current flowing in the first pole is substantially zero; reconnect the first breaker pole to the same split-phase power source and disconnect the second pole of the breaker from the same split-phase power source; verify that current flowing in both of the breaker poles is substantially zero; disconnect the first pole from the currently selected split-phase power source and connect it to one phase of the other split-phase power source; and connect the second breaker pole to the other phase of the other split-phase power source.

Yet another aspect relates to an electrical circuit breaker panel configured to selectively distribute power to a plurality of branch circuits or appliances, each receiving power from one of a primary power source and a secondary power source through an appropriate circuit breaker associated with each branch circuit or appliance. The panel includes controlled switches configured to disconnect each branch circuit or appliance from, and to connect it to, the first or second power source. The panel further includes a controller configured to control the switches and register switch integrity indicators. The panel also includes current sensors configured to monitor current draw in associated branch circuits or appliances. When one current sensor indicates that the current in an associated branch circuit or appliance is not zero and the controller controls an associated controlled switch to disconnect the branch circuit or appliance from a currently selected power source, the controller is configured to, in response to the associated current sensor indicating that the current draw has become substantially zero, set the associated switch integrity indicator to a positive indication; and in response to the associated current sensor indicating that the current draw has not become substantially zero, set the associated switch integrity indicator to a negative indication.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a block diagram of an intelligent electrical panel.

FIG. 2 is a diagram showing arcing across switch contacts as power source selection is changed.

FIG. 3 is a schematic diagram of a set of non-latching relays for power source selection.

FIG. 4 is a schematic diagram of a set of latching relays for power source selection.

FIG. 5A is a perspective view of a Hall Effect current sensor chip.

FIG. 5B is a diagram showing a magnetic field induced by current flowing in a PCB trace.

FIG. 5C shows two orientations of the Hall Effect current sensor chip of FIG. 5A relative to a PCB trace for which current is to be sensed.

FIG. 6 shows two schematic diagram of a circuit for amplifying the output of certain current sensor chips.

FIG. 7 is a schematic diagram of two adjacent current sensors circuits.

FIG. 8 is a schematic diagram of the circuit of FIG. 7 with the addition of feedback to reduce crosstalk.

FIG. 9 is a schematic diagram of two adjacent current sensor circuits using different current sensor chips than the circuits of FIGS. 7 and 8.

FIG. 10 is a full electrical schematic diagram of two adjacent current sensor circuits using the current sensor chips of FIG. 9.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

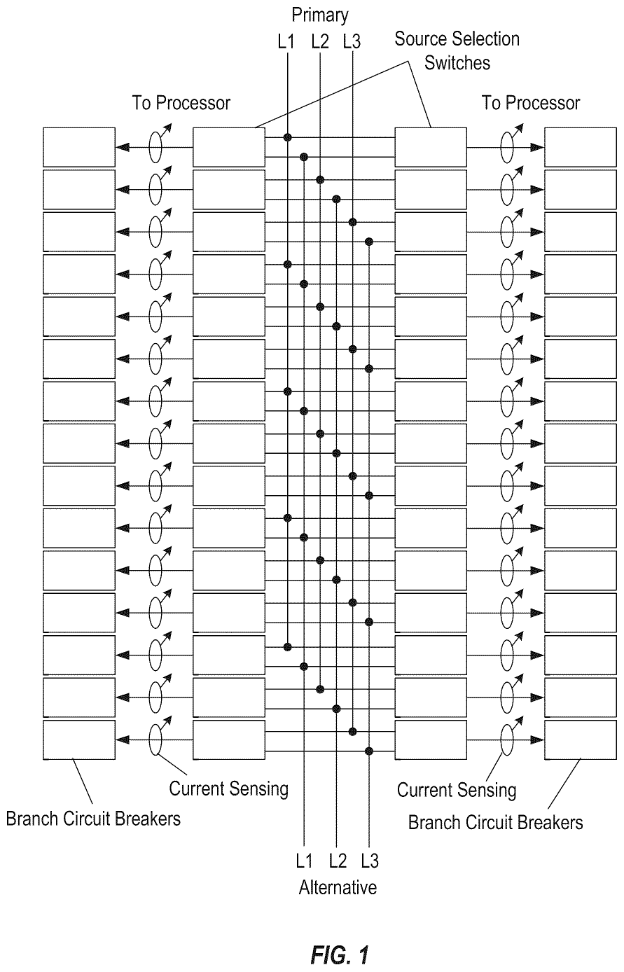

FIG. 1 shows a block diagram of an intelligent electrical panel according to aspects of the present disclosure. FIG. 1 illustrates a 3-phase panel, as may be suitable for 120/208 volt commercial installations, and thus has three primary source input phase busses labelled L1, L2, and L3 and three alternative source phase busses labelled likewise.

A phase from the primary source buss and a corresponding phase from the alternative source buss are connected to each of the source selection switching blocks. The selected source is fed from the source selection switches through associated current sensors to branch circuit breakers. Hall effect magnetic field sensing devices can be used as “no contact” current sensors, which do not interrupt the current path and do not contact line voltage. This simplifies connecting their outputs to a processor that is usually desired to be isolated from line potentials. The processor also controls the source selection switches in dependence on the current readings from the current sensors, among the other factors listed above.

One of skill in the art will readily appreciate that FIG. 1 can be reduced to a single phase, e.g., 240 volt system having only one L1 buss from each of the primary and secondary sources, as might be used in European residential installations, or to a split-phase 120-0-120 volt system, as used in US residential installations and having only an L1 and L2 buss from each source. In a three phase system, consecutive breakers connect to L1, L2, and L3 repeatedly, such that inserting a triple, 3-phase breaker in any position picks up all three phases. Likewise, a double pole breaker can be inserted in any pair of consecutive slots of a three phase panel to pick up two of the three phases, between which 208 volts would be obtained in a 120/208 volt system (or 127/240 in Mexico). In a split phase system, a two-pole breaker can be inserted in any pair of consecutive slots to pick up two antiphase 120 volt lines with 240 volts between them for 240 volt appliances.

To preserve flexibility, a split-phase panel should permit single pole or double pole breakers to be inserted anywhere; this necessitates that all source selection switches be single pole switches, and the processor is programmed on installation to indicate which slot pairs contain double pole breakers. Likewise, in a three-phase installation the processor is programmed to designate which slot pairs contain 2-pole breakers and which slot triples contain 3-phase breakers. The processor must then switch all phases of a multiphase breaker from one source to another source simultaneously, so that mixed power from both sources is never applied to a load. One reason for avoiding mixed sources is that the two sources are not necessarily synchronized, so the phase relationship might not be as desired; another reason is to avoid backfeed through the load from the alternative energy source to the primary source when the primary source is in outage. For the latter reason, the source selection switching provides an intermediate OFF position wherein the load is connected to neither source. This is also used for single-pole switching to avoid source-to-source arcing.

### Power Source Switching

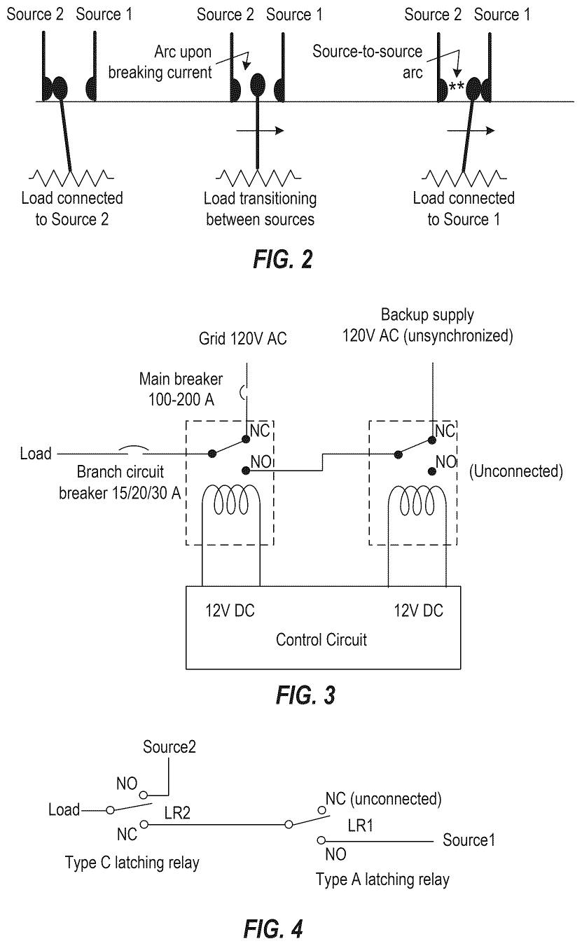

FIG. 2 illustrates the undesirable issue of source-to-source arcing that can occur when switching a load between two unsynchronized sources using a single SPDT relay. FIG. 2 shows that the arc that arises when breaking contact with Source 2 persists until the relay moving contact meets Source 1, thereby allowing source-to-source arcing that is not currently limited by a breaker, and thus potentially catastrophic.

Relays are electromechanical switches that change switch states upon the application of current to a coil, creating a magnetic field. Non-latching SPST relays that are open-circuit when the coil of the relay is not energized, and close upon the coil being energized, are referred to as type A. Conversely, non-latching SPST relays that are closed when the coil of the relay is not energized, and open upon the coil being energized, are referred to as type B. Non-latching SPDT relays, referred to as type C, connect an input with a first contact, typically labeled NC for “Normally Closed” when the coil is not energized, and connect the input to a second contact, labeled NO for “Normally Open” when the coil is energized. Although type A and B relays have only two terminals, for consistency, in FIGS. 3 and 4, all three types are depicted with both NC and NO contacts, with one of them left unconnected.

FIG. 3 shows a two-relay circuit based on non-latching relays that avoids source-source arcing. The load on the left is connected through its branch circuit breaker to an SPDT source selection relay (said to have a type ‘C’ contact arrangement) that has its normally closed contact connected to the primary source, i.e., the utility grid, and its normally open contact connected to the alternative or back-up supply through a second relay, a type ‘B’ relay which is normally closed when unenergized.

In this arrangement, neither relay coil is energized when the grid is the selected source, thus avoiding power drain from the grid. In switching from grid to back-up, the second relay is first energized to open it before the SPDT type C relay is energized to flip the source selection. After waiting about half a cycle, or 10 mS, for any arc upon breaking grid current to subside, the second, type B relay is de-energized to reconnect the back-up supply to power the load. Thus, only one relay remains energized when the load is powered from the back-up source. It can be seen that there is a momentary OFF position during switching; however, both relays must be energized to stay in the OFF state and therefore the OFF state is not the default state when the unit is not powered at all. The default state in the absence of power is with all loads connected to grid, and if the grid suddenly becomes live, all loads are powered simultaneously. It may be more desirable if the power-up state was with no loads powered, allowing the grid or other source to be loaded one circuit at a time for a “soft start.” A soft start can be provided by using latching relays that can be left in a default OFF state upon power down, providing enough stored energy is made available to switch the latching relays to the default state upon loss of all power. The stored energy can be provided by a suitable capacitor.

FIG. 4 shows a similar arrangement using latching relays. Which source is the grid, and which is back-up, is now irrelevant from a coil power viewpoint, but there is another reason to exchange sources as compared to the non-latching relay arrangement: Utility grids are capable of supplying very high momentary currents into short-circuit faults before an overcurrent breaker trips. Typically, US electric utilities limit this fault current for residential installations to 5000 amps r.m.s. by deliberate leakage inductance of 64 uH in the pole transformer. Electromechanical breakers have been measured to require about 4 mS to trip at this fault current level. Many small relays do not survive this current for 4 mS, and may require faster-acting fuses for protection. An even more stressful condition can occur when a relay closes into a short circuit. This can occur, for example, when a short circuit load trips a back-up inverter, which can occur faster than a branch circuit breaker can operate, with the result that the intelligent panel software switches the short circuit load to grid in an attempt to maintain service. Thus, in the above relay configuration of FIG. 4, if Source 1 is the grid, the type A relay is the last one to close to the grid upon switching, and thus takes the full fault current. Since type A relays of a given size typically have more robust contacts than type C relays, this motivates using the type A relay to interrupt or connect the grid supply, while the type C relay connects or interrupts the lower-power back-up source, Source 2. Note that, in the case of latching relays, there is no distinction between type A and type B relays, as either the open or closed state can be maintained with no continuous coil power; however, in order to distinguish the states, the contacts in FIG. 4 have been labelled NO and NC, as in the case of non-latching relays.

The operation of FIG. 4 comprises latching the type C relay in the NO state while the type A relay is latched in the NC state, in order to power the load from Source 2. To switch to Source 1, the type C relay is latched to the NC state and then, after a short delay to allow arcing to subside, the type A relay is latched to the NO state. This is one less relay operation than in the case of FIG. 3, as the type A relay was already open at the start. Similarly, to switch the load from Source 1 to Source 2, the type A relay is latched to the NC state, and after a short delay to allow arcing to subside, the type C relay is switched to the NO state.

One common failure mode that can occur if a relay is subject to a large current overload is contact welding. If the type C relay welded in one state, no switching of the load between sources would occur, and thus no source-to-source arcing would result. If, on the other hand, the type A relay welded closed (which is the only way it could fail, as there is no physical contact in the open position), then switching from Source 1 to Source 2 could occur without first interrupting Source 1 with the type A relay, resulting in the type C relay breaking the Source 1 current and causing Source 1 to Source 2 arcing, as illustrated in FIG. 2. In order to guard against the type A relay welding, a test is performed to verify that Source 1 current is first interrupted by the type A relay before closing the type C relay to Source 2. This is done by utilizing the current sensor associated with the branch circuit. Thus, to effect switching from Source 1 to Source 2, the load current before switching is measured and the value stored in the processor; the type A relay is then latched to the open state and the current measured again and compared with the stored value to verify it has dropped to substantially zero. If the current does not change, this indicates the type A relay may be welded, and several attempts to operate it can be made before abandoning the operation. Upon verifying that the type A relay has interrupted current, the type C relay may be latched to the NO state and the current again measured to verify it has returned to the previous value. If current does not return to substantially the previous value, several attempts can be made to operate the type C relay before abandoning the operation. In the latter case, it can be chosen to return the load to the grid by operating the type A relay, or to leave the load unpowered and in either case a failure indication can be provided by flashing an LED or similar alarm to the user to indicate the faulty branch circuit.

Because AC current varies from a positive peak through zero to a negative peak again, it is meaningless to compare instantaneous measurements to determine if current has changed due to switching. By sampling the AC current several times over each cycle and computing the amplitude of the fundamental component from one cycle's worth of samples, the computed amplitude is substantially independent of the timing of sample collection relative to the cycle. Details of performing AC measurements in this way are given in U.S. Pat. No. 11,460,488 to the current inventor.

In the case of switching 2-pole or 3-pole, 3-phase circuits, all two or three phases must be switched more or less simultaneously, while guarding against leaving the load receiving mixed power from both sources to due to a relay welding. The test that relay A interrupts current from the grid must therefore be performed independently for each pole. Thus, to switch a load from grid to back-up, the type A relay of the first phase is operated to interrupt grid current and the current for that phase is measured before and afterwards to verify interruption. The relay must then be closed again to allow the same test to be performed on the second phase of a double pole breaker. When both type A relays are confirmed to interrupt the current, they are left in the open state and then both type C relays are latched to the NO position to connect the load to Source 2. A final current measurement of both phases is performed to verify that both type C relays have moved and that the current has returned to the expected value. If not, the circuit can be returned to grid or placed in the OFF state and a failure indication provided to the user.

In the case of a two-pole circuit that does not use neutral, when one type A relay interrupts grid power, the current in both phases should fall to zero, and this can be used as an additional check. The processor measures all circuit currents substantially simultaneously and so this does not imply additional delay. The processor is also envisaged to comprise a relay driver chip that can be programmed with a multi-bit word that causes several relays to change state simultaneously. In the case of a 3-phase, 3-wire circuit that does not use neutral, the type A relays of two phases must be opened to observe zero current on all three phases, and this is recommended so that the load is not momentarily powered by only two out of three phases, which might have unknown consequences. Thus, the type A relays of phases L1 and L2 would first be opened and all three phase currents verified to fall to zero, then one of them would be closed while opening the type A relay for L3 simultaneously and verifying that all three currents remained zero, thereby verifying that no one of the type A relays was welded closed. In the case of a three phase, 4-wire circuit that uses neutral, opening two phases is only guaranteed to cause the current in those two phases to drop to zero. In both the two-pole and three-pole cases, upon all type A relays being opened, all type C relays can be switched to connect Source 2 simultaneously, followed by a check that the current in all phases had returned to substantially the same value as obtained before switching sources, and if not, a reversion to grid or the OFF condition can be chosen.

The source selection switching has some additional considerations for split-phase power sources and two-pole breakers. For example, an electrical circuit breaker panel is configured to selectively distribute split-phase power to a branch circuit or appliance from one of a primary split-phase power source and a secondary split-phase power source, through an appropriate two-pole circuit breaker. The panel includes a set of controlled switches configured to independently connect each pole of the circuit breaker to, and disconnect it from, each of the primary or secondary split-phase power sources. The panel further includes a controller configured to control the switches to power the branch circuit or appliance from the primary or secondary split-phase power source. In changing the selection for the two-pole breaker from one of the primary or secondary split-phase power sources to the other, the controller is configured to control the switches in the following sequence:
1. disconnect a first pole of the two-pole breaker from a currently selected split-phase power source and verify that current flowing in the first pole is substantially zero;
2. reconnect the first breaker pole to the same split-phase power source and disconnect the second pole of the breaker from the same split-phase power source;
3. verify that current flowing in both of the breaker poles is substantially zero;
4. disconnect the first pole from the currently selected split-phase power source and connect it to one phase of the other split-phase power source; and
5. connect the second breaker pole to the other phase of the other split-phase power source.

In some aspects, the controller is further configured to change the selection of the split-phase power source for a two-pole breaker circuit only when the associated branch circuit or appliance is drawing substantially zero current.

In another aspect, the controller assigns a switch integrity indicator to a controlled switch, the switch integrity indicator being indicative of whether power source switching can be performed for a branch circuit or appliance, in response to current sensed in the branch circuit or appliance. In this aspect, an electrical circuit breaker panel is configured to selectively distribute power to a plurality of branch circuits or appliances, each receiving power from one of a primary power source and a secondary power source through an appropriate circuit breaker associated with each branch circuit or appliance. The panel includes controlled switches configured to disconnect each branch circuit or appliance from, and to connect it to, the first or second power source. The panel also includes a controller configured to control the switches and register switch integrity indicators. the panel further includes current sensors configured to monitor current draw in associated branch circuits or appliances. When one current sensor indicates that the current in an associated branch circuit or appliance is not zero and the controller controls an associated controlled switch to disconnect the branch circuit or appliance from a currently selected power source, the controller is configured to:
in response to the associated current sensor indicating that the current draw has become substantially zero, set the associated switch integrity indicator to a positive indication; and
in response to the associated current sensor indicating that the current draw has not become substantially zero, set the associated switch integrity indicator to a negative indication.

In some aspects, the controlled switches are latching relays.

Note that the above switching, including current checks, can only be performed for circuits that are drawing current. To address switching sources for appliances that are not ON, energy management algorithms must first be described.

### Energy Management Algorithms

Because it is attractive to use free energy from the sun, and because the capital cost of solar electricity generation is now the lowest of all methods, solar energy penetration is on an unstoppable upwards trajectory. It must therefore be anticipated that the day will come when the generation of solar energy during peak sun at noon is greater than total demand at that time, and it will be impossible to absorb the excess into the grid. This has already happened in certain locales for residential solar in California, due to people not being at home at midday to “self-consume.”

In the patents listed above, the current inventor has proposed systems that incorporate battery storage that was previously only used in off-grid systems. In other patents, the intelligent panel was envisaged to communicate with intelligent appliances such as dishwashers, tumble dryers, and clothes washers so that they could be controlled to operate when the user was not at home, but sun was out. Own solar power can be stored in batteries for future use in a grid outage or at night, or can be used to operate appliances in a “deferred run” mode when sun is out.

For the vast majority of the time, grid will be up, and so the question for energy management algorithms is how to decide what to place on solar power for self-consumption in order to save money on the user's utility bill, while avoiding feeding power back to the grid. Solar inverters powered by a solar-charged battery have a maximum continuous power rating and also a limit on peak power that can be supplied over shorter timescales, such as ten minutes, or even two seconds. It is desired to self-consume as much of the household needs as possible from solar-derived power, without the total load on the solar inverter exceeding the above limitations, and while meeting other constraints such as not discharging the battery below a level that might be needed if the grid goes out. For example, consider a household with two adults who go to work and two children who go to school: It may be desired to maintain enough charge in the battery to be able to complete normal morning ablutions and get off to work and school in the case the grid goes out and before the sun comes up. The number of battery kilowatt hours to achieve this can be predicted and also learned by an intelligent panel for a particular household. For the majority of occasions when grid is up, however, and observing the latter goal for battery reserve power, it is desired to utilize as much solar power as possible when the house occupants are not at home during the day. Candidates for self-consumption while the occupants are out include: battery charging, HVAC, water heater, fridge, freezer, smaller loads, and appliances such as tumble dryer, dish washer, and clothes washer, possibly set to deferred run. When the occupants are home or return home, other appliances may be activated such as TVs, computers, microwave, sink disposal, lights, electric iron, hairdryers, etc.

Some appliances, such as those with motors and HVAC in particular, have high start-up current needs, which must not in total exceed the inverter's continuous or momentary specification limits.

Deliberation has concluded that, when the grid is up, the best strategy is for the inventive intelligent panel to maintain all branch circuits and appliances which are OFF connected to grid power. Thus, when an appliance starts operating, the initial startup current is taken from grid and when current measurement indicates that the current has fallen to the continuous running level, it can be decided whether there is enough inverter capacity to switch it to solar inverter. By taking high startup current always from grid, it is therefore possible to power many more appliances from the inverter if only the running current has to be accommodated. For example, measurements show a well pump takes 33 amps of start-up current from a 240 volt supply, but falls to 7 amps running current in about two seconds. Therefore, if started on the grid, only 7 amps will be switched to be consumed from inverter. Since only appliances already consuming power are thus switched from grid to inverter, this satisfies the switching algorithm's mitigating potentially welded contacts by measuring current change before and after switching a relay. In this mode (grid available), when an appliance powered by solar switches off, it is switched back to grid and other candidates for the available solar+battery power can be switched from grid to solar.

When the grid is in outage, the energy management algorithm is different. Now it is desired to switch as many appliances as possible that were consuming power from grid to solar so as to maintain their operation. The power they require was measured while they were powered from the grid, and the processor is able to execute the power management algorithm and switch circuits so fast that little interruption of power occurs. If it is not possible to switch all circuits to solar because of inverter power limitations, preset user priorities are employed to select circuits in order of priority. It is also desired to switch OFF circuits to solar inverter back-up power, so that if the user should switch a circuit ON, he gets the impression of power being available to most circuits. Moreover, certain appliances that run intermittently, such as refrigerator, HVAC, well pump, water heater, and such can be left off for a predetermined time and offered power at different times. If only a short grid outrage is expected, HVAC may not need to run at all, as the house will change temperature slowly. Thus a refrigerator, for example, which may the highest priority appliance to be backed-up, can be allowed to run until current measurement detects that it has switched OFF, and then the relay switching may be placed in the OFF state for a predetermined time, such as 30 minutes, before it is offered power again; meanwhile other circuits, ON or OFF, can be switched to the solar inverter. Any OFF circuit switched to solar must have the characteristic that its startup current plus the current of any ON circuits must not exceed the short-term peak power specification of the inverter, and its running current plus that of ON circuits must not exceed the continuous power rating of the inverter. If such a circuit turns ON, then the current requirement of any other of the OFF circuits switched to back-up must not exceed the reduced headroom available, and their source selection relays must be moved to the OFF state if they do. An assumption is that two OFF circuits will not be switched ON so close in time (e.g., 40 mS) that the processor cannot react to disallow the second one if it would result in inverter overload.

It will appreciated that the switching of any circuit that is OFF or has just turned OFF cannot use current measurement to verify switching; on the other hand, relay contact welding is unlikely to occur when switching a circuit consuming little or no current. Also, when in the grid outage mode, if an appliance is taken off solar to give another appliance an opportunity for power, it is not switched to grid but to the OFF state; thus, the type A relay does not need to move and remains open. Switching an ON appliance to the OFF state by moving only the type C relay can be verified to have succeeded by observing the current drop.

Thus, a power management algorithm according to aspects of the present disclosure has two modes, a first mode for the most usual case of both power sources being available, and a second mode for backup power when the primary source is in outage. The first mode strives to minimize the utility bill, while the second mode strives to provide power opportunities for as many circuits as possible, based on user priorities, inverter power capacity, and battery charge. During long grid outages, the second mode may also incorporate load shedding to ensure that the highest priority loads are powered for as long as possible. In some aspects, the algorithms additionally use time of day, and especially time till sunrise and time-of-day based utility tariffs best to achieve their objectives.

Accurate current measurement is important in the operation of aspects of the present disclosure. When Hall Effect current sensors are used, crosstalk from adjacent circuits can affect accuracy. Crosstalk of approximately 5% between 1-inch spaced breaker circuits has been measured. This means, for example, that a water heater consuming 18 amps can cause an apparent current of 0.9 amps to be measured in an adjacent circuit. Such crosstalk can be compensated in slow time by software. It was proposed in the above-mentioned U.S. Pat. No. 11,460,488 to average current measurements over a 1-second interval, as more frequent values were of little interest. Crosstalk compensation can be performed at this once per second interval by matrix methods using reasonable microprocessor power, providing that the 1-second complex correlations between all the different input voltages are also computed over the same 1 second intervals, and saved. However, crosstalk compensation of the faster, 1-cycle current measurements is required for use in the relay switching algorithms. Aspects of the present disclosure perform this crosstalk compensation in the continuous time analog domain, as described below.

### Hall Effect Current Sensing Employing Crosstalk Compensation

Linear, Hall-Effect magnetic field sensors have the advantages for current sensing of being completely electrically isolated from the power circuit, and they are fully integrated and ready for PC Board mounting.

Single-axis Hall Effect current sensor ICs sense the magnetic field along one axis only, and must be mounted in such a way that that axis coincides with the magnetic field produced by the current to be sensed.

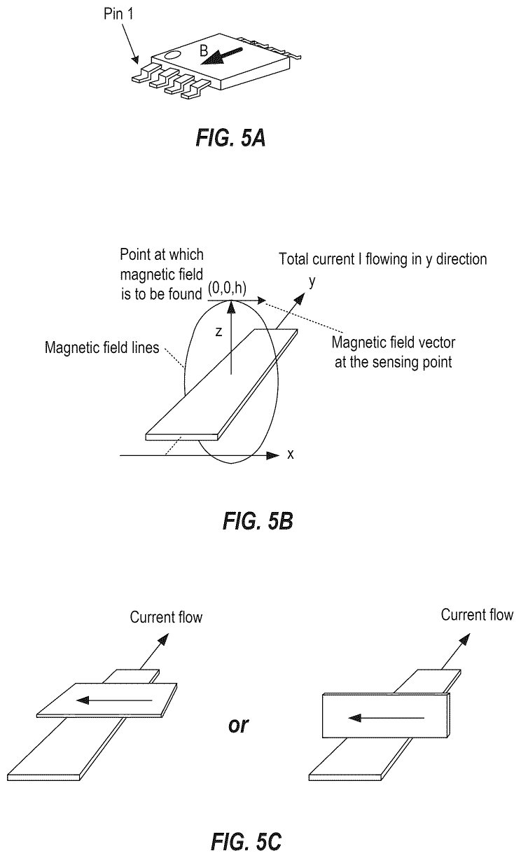

Most magnetic field sensor chips have their magnetic field sense axis normal to the chip, so for a flat, surface mounted chip, that direction is normal to the board. However, some have their sense axis along the chip. FIG. 5A, shows the field orientation of the Melexis MLX91025 chip.

FIG. 5B shows that the magnetic field from a current in a PCB trace is parallel to the PCB and at right angles to the current flow. FIG. 5C shows the two possible orientations for the Melexis chip to sense current in the PCT trace.

### Noise and Nyquist Bandwidth

The sampling rate of the A-to-D conversion is 8×60 Hz=480 Hz. Therefore, the bandwidth must be restricted to be less than the Nyquist bandwidth of 240 Hz before A-to-D conversion. It is only necessary to measure the 60 Hz fundamental component of the current, as this is all that correlates with the voltage, which is a good sinewave, in order to yield a power measurement. It is also desirable to convert any non-sinusoidal current waveforms to nearer to a 60 Hz sinusoid by attenuating harmonics. This is done mainly in software in the digital domain by a simple Fourier Analysis, e.g., in an ATTINY® processor which extracts the 60 Hz fundamental component of the current waveform for eight breaker circuits and nulls out harmonics. The Fourier analysis yields cosine and sine amplitudes once per cycle, as a complex number which embodies phase information and so discriminates between resistive, capacitive, and inductive currents, and also determines the direction of power flow.

This is called 4-quadrant metering, which how all modern metering works.

The output voltage from a Hall Effect sensor is noisy, so it is also necessary to limit the noise bandwidth before A-to-D conversion, and to perform substantial further software averaging in the digital domain by averaging 60 cycles over each one-second period. The one-second averaging must be done after multiplying by the conjugate of voltage to cancel phase drift.

### Amplifier Circuit

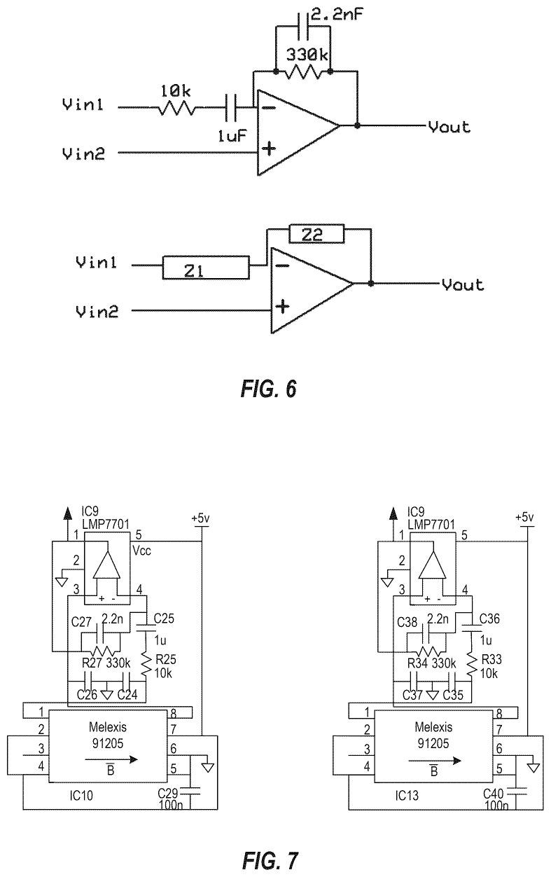

When following the Hall Effect sensor with substantial amplification, the sensor's output DC offset must be DC blocked. This is especially true when the Hall Effect sensor is proximate to a relay that can radiate a DC magnetic field. FIG. 6 depicts an amplifier circuit that comprises a 219 Hz low pass pole and a 16 Hz high pass pole (DC block), which together deliberately give substantially zero net phase shift at 60 Hz. The latter fact simplifies crosstalk cancellation. The circuits of FIG. 6 follow the Melexis Hall Effect sensor, which has been omitted for simplicity. Its gain to Vin1 is given by

$$\begin{matrix}\frac{{V}_{out}}{{V}_{in 1}} = \frac{- Z 2}{Z 1} = \frac{- 1}{[ ( {R}_{1} + 1 / j ω {C}_{1} ) ( 1 / {R}_{2} + j ω {C}_{2} ) ]} \\ = \frac{- 1}{[ ( {R}_{1} / {R}_{2} + {C}_{2} / {C}_{1} ) + j ( 0.007568 - 0.008 \text{.37} )} \\ = \frac{- 1}{( 0. 305 - 0.000 \; 457 j )} \\ = - 32.78 - 0.491 j\end{matrix}$$

which is only 0.86 of a degree in phase from being real.

The gain from Vᵢₙ₂ to Vₒᵤₜ is 1.0 minus the above, that is, 33.76+0.491j

In one aspect, the Vᵢₙ₂ input is used to subtract a fraction of the Vᵢₙ₁'s from adjacent branch circuits, so as to cancel crosstalk as well as possible. Final crosstalk cancellation for accuracy enhancement can be done digitally in software at a rate of approximately once per second.

FIG. 7 shows the circuit of two adjacent current sensors before adding crosstalk cancellation.

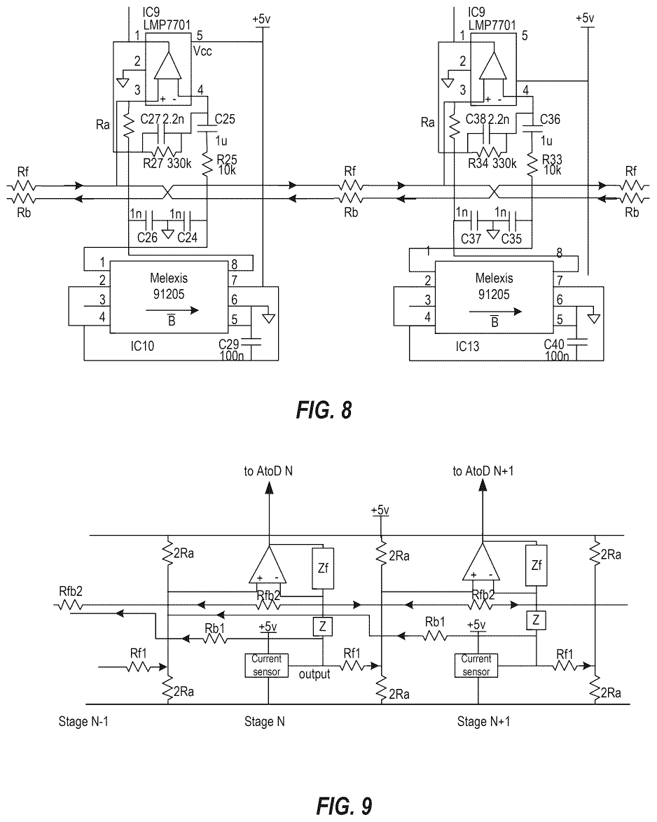

FIG. 8 is the circuit of FIG. 7 modified by the addition of forward and backward crosstalk cancellation resistors Rf and Rb. These feed the outputs of adjacent current sensors into the opposite polarity (+ve) or Vᵢₙ₂ input of the LM7701 OpAmp to cancel the unwanted crosstalk.

The amount of crosstalk cancelled is roughly a fraction Ra/Rf of the current sense output of the circuit to the left and a fraction Rb/Ra of the current sense output of the circuit to the right. If crosstalk was 5% for example, Ra/Rf would be set to 1/20, for example Ra=1 kΩ and Rf=Rb=20 kΩ. If the relay board layout is not left/right symmetrical, crosstalk may not be left/right symmetrical and Rf and Rb will then be different.

The above only attempts to reduce crosstalk from adjacent breakers. Additional components may be used to cancel crosstalk from two breaker slots away. The resistors are chosen to nominally cancel crosstalk after measuring what it turns out to be for a given relay board design. Software provides the final enhancement of measurement accuracy using software coefficients determined in an automatic final calibration procedure.

The MLX91205 part is becoming obsolete and its replacement, the MLX91208 or MLX91216, has a different pinout than the MLX91205. In particular, it lacks the Vcc/2 reference output which the MLX91205 had. Therefore, the Vcc/2 reference for the following opamp is provided by splitting the 5v Vcc with two equal resistors. These, however, provide the equivalent of the resistor Ra in the above crosstalk cancellation circuit, and allow cancelling crosstalk from two breaker slots away.

FIG. 9 shows the circuit using the MLX91216. This circuit shows two simplified adjacent instances of the eight current sensors per current sensor board. The current sensor is amplified by the opamp with feedback back impedance Zf and input impedance Z, which together give Zero phase shift at 60 Hz.

The other input (+ve) of the opamp receives a Vcc/2 bias supplied by the voltage splitter composed of resistors 2Ra from 5v to ground. A crosstalk cancellation signal is also injected into this input. The crosstalk cancellation consists of a fraction fed forward from the output of stage N−1 through resistor Rf1 on the left, and a fraction fed backwards from stage N+1 through resistor Rb1 to the right. Likewise, stage N supplies a feedforward signal from its output through Rf1 to stage N+1 and a backwards cancellation signal through its Rb1 to stage N−1.

The resistors Rfb2 provide a fraction of stage (N−1)'s cancellation signal to stage N and of stage N's signal to stage N−1 and likewise reciprocally between every adjacent breaker pair. Therefore, stage N receives a cancellation signal through Rfb2 from stage N−2 and stage N+1 receives a cancellation signal through Rfb2 from stage N−1. Likewise, stage N−1 receives a backwards cancellation signal from stage N+1, etc.

The cancellation of crosstalk from the breaker to the left and the breaker to the right are thus independently adjustable by means of Rf1 and Rb1 and the cancellation from two stages away is adjustable by choice of Rfb2.

Any residual crosstalk that must be removed to meet accuracy goals is done in software on the one-second average measurements, not once per cycle.

The fraction of stage N output fed forward to stage N1 is roughly Ra/Rf1 and the fraction fed back to stage N−[1 is roughly Ra/Rb1, while the fraction of a sensor output fed forward two stages is roughly (Ra/Rf1)×(Ra/Rfb2) and the fraction fed back two stages is roughly (Ra/Rb1)×(Ra/Rfb2).

For example, if adjacent crosstalk is 5% then Ra/Rf1 or Ra/Rb1 should be about 20, e.g., if 2Ra=2.2k, Ra=1.1k, then Rf1=Rb1=22k.

If crosstalk from two stages away is 1%, then Ra/Rfb2 should provide a further factor of 5 attenuation, that is Rfb2=5.6K.

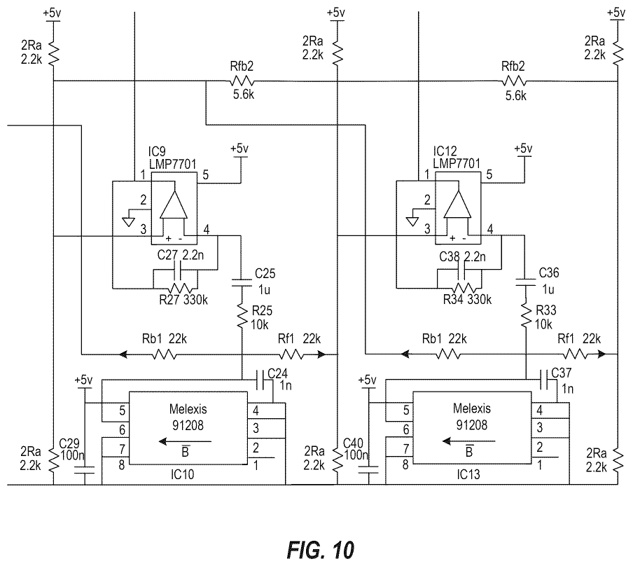

A full circuit with the MLX91208 or MLX91216 replacement part with crosstalk cancellation using the above tentative values is shown in FIG. 10.

Computation of the crosstalk cancellation values may be done with the following formulae:

Compute Go using

$$Go = \frac{( 2 / R 1 )}{[ 1 - α 1 - α 2 - β 1 ( 1 - β 1 ) - β 2 ( 1 - β 2 ) ]} where$$

α1 is the required attenuation from the sensor 1 inch away
α2 is the required attenuation from the sensor 1.5 inches away
β1 is the additional attenuation from the compensation node 1 inch away to cancel crosstalk from 2.5 inches away, and
β2 is the additional attenuation from the compensation node 1.5 inches away to cancel crosstalk from 2.5 inches away.

### Then

$$\begin{matrix}Rf 1 Rb 1 = 1 / ( α 1 Go ) \\ Rf 2 = Rb = 1 / ( α 2 Go ) \\ Rfb 1 = 1 / ( β 1 Go ) and \\ Rfb 2 = 1 / ( β 2 Go ) .\end{matrix}$$

The desired attenuation numbers α1 and α2 are increased by the factor (1+Gain)/Gain where Gain is the OpAmp gain from its inverting input to the output (32.78 currently).

β1 and β2 do not need to be increased by this factor because they are additional attenuation values.

Crosstalk Cancellation Resistors before Standardization

| | |
|---|---|
| RF1 = 24665.27 | RF2 = 70916.59 |
| RB1 = 24665.27 | RB2 = 70916.59 |
| RFB1 = 3223.002 | RFB2 = 9204.749 |

### Crosstalk Cancellation Resistors Conformed to Standard E4 Series Values:

| | |
|---|---|
| RF1 = 24000 | RF2 = 68000 |
| RB1 = 24000 | RB2 = 68000 |
| RFB1 = 3300 | RFB2 = 9100 |

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features and advantages of the enclosed aspects will be apparent from the description. As used herein, the term “configured to” means set up, organized, adapted, or arranged to operate in a particular way; the term is synonymous with “designed to,” or with respect to processing circuitry, “programmed to.”

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A switching circuit configured to switch a load between first and second power sources without the possibility of source-to-source arcing, comprising:
a first relay having a first terminal, and a second terminal connected to the first power source;
a second relay having a first terminal connected to the load, a second terminal connected to the second power source; and a third terminal connected to the first terminal of the first relay; and
a control circuit configured to independently and selectively energize the first and second relays, with predetermined delays interposed between switching actions, so as to switch the load between the first and second power sources while avoiding source-to-source arcing.

2. The switching circuit of claim 1 wherein
the first relay is a non-latching type B relay;
the second relay is a non-latching type C relay, wherein the second terminal is a normally closed (NC) terminal that is connected to the first terminal only when the relay is not energized, and the third terminal is a normally open (NO) terminal that is connected to the first terminal only when the relay is energized; and
when neither relay is energized, the load is connected to the second power source.

3. The switching circuit of claim 2 wherein the control circuit is configured to switch the load from the second power source to the first power source by:
energizing the first relay to disconnect the first terminal from the second terminal;
energizing the second relay to switch first terminal from the second terminal to the third terminal;
waiting a predetermined duration, sufficient for any current breaking arc to subside, during which both relays are energized and the load is not connected to either the first or second power source; and
subsequently de-energize the second relay to connect the first terminal to the second terminal.

4. The switching circuit of claim 3 wherein only the second relay must be energized to maintain the load connected to the first power source.

5. The switching circuit of claim 3 wherein the second power source is a primary power source and the first power source is an alternative power source.

6. The switching circuit of claim 1 wherein
the first relay is a latching relay;
the second relay is a latching type C relay; and
the controller is configured to place the first and second relays in a default state wherein the first relay is configured for type A functionality, and the second relay is configured to connect the first terminal to the third terminal.

7. The switching circuit of claim 6 wherein the controller is configured to:
place the first and second relays in the default state upon a loss of power from both first and second power sources, using available short-term stored energy; and
upon resumption of power from the first source, selectively switch the load to the first power source by switching the first relay, at a time different to other loads, so as to manage instantaneous current flow from the first power source.

8. The switching circuit of claim 7 wherein the short-term stored energy is provided by a capacitor.

9. The switching circuit of claim 6 wherein the control circuit is configured to switch the load from the first power source to the second power source by:
switching the first relay to disconnect the first terminal from the second terminal;
waiting a predetermined duration, sufficient for any current breaking arc to subside, during which the load is not connected to either the first or second power source; and
switching the second relay to switch the first terminal from the third terminal to the second terminal.

10. The switching circuit of claim 6 wherein the first power source is a primary power source and the second power source is an alternative power source.

11. An electrical circuit breaker panel configured to selectively distribute split-phase power to a branch circuit or appliance from one of a primary split-phase power source and a secondary split-phase power source, through an appropriate two-pole circuit breaker, comprising:
a set of controlled switches configured to independently connect each pole of the circuit breaker to, and disconnect it from, each of the primary or secondary split-phase power sources;
a controller configured to control the switches to power the branch circuit or appliance from the primary or secondary split-phase power source;
wherein to change the selection for the two-pole breaker from one of the primary or secondary split-phase power sources to the other, the controller is configured to control the switches in the following sequence:
disconnect a first pole of the two-pole breaker from a currently selected split-phase power source and verify that current flowing in the first pole is substantially zero;
reconnect the first breaker pole to the same split-phase power source and disconnect the second pole of the breaker from the same split-phase power source;
verify that current flowing in both of the breaker poles is substantially zero;
disconnect the first pole from the currently selected split-phase power source and connect it to one phase of the other split-phase power source; and
connect the second breaker pole to the other phase of the other split-phase power source.

12. The panel of claim 11 wherein the controller is further configured to change the selection of the split-phase power source for a two-pole breaker circuit only when the associated branch circuit or appliance is drawing substantially zero current.

13. An electrical circuit breaker panel configured to selectively distribute power to a plurality of branch circuits or appliances, each receiving power from one of a primary power source and a secondary power source through an appropriate circuit breaker associated with each branch circuit or appliance, comprising:
controlled switches configured to disconnect each branch circuit or appliance from, and to connect it to, the first or second power source;
a controller configured to control the switches and register switch integrity indicators; and
current sensors configured to monitor current draw in associated branch circuits or appliances;
wherein when one current sensor indicates that the current in an associated branch circuit or appliance is not zero and the controller controls an associated controlled switch to disconnect the branch circuit or appliance from a currently selected power source, the controller is configured to
in response to the associated current sensor indicating that the current draw has become substantially zero, set the associated switch integrity indicator to a positive indication; and
in response to the associated current sensor indicating that the current draw has not become substantially zero, set the associated switch integrity indicator to a negative indication.

14. The panel of claim 13, wherein the controlled switches are latching relays.
